(19) United States
(12) Patent Application Publication
(10) Pub. No.: US 2006/0013172 A1
(43) Pub. Date: Jan. 19, 2006

(54) RSSI threshold selection for channel measurements based on RSSI of the received packets

(75) Inventors: Paivi M. Ruuska, Tampere (FI); Arto Palin, Viiala (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/892,963

(22) Filed: Jul. 16, 2004

(51) Int. Cl. H04Q 7/24

(52) U.S. Cl. 370/338

(57) ABSTRACT

A device for communicating via a radio communications channel, having a frequency that can hop between a plurality of frequencies, in a network comprising a plurality of devices, the device comprising: a radio transceiver for communicating with a first one of the plurality of devices via a first radio link using the radio communications channel; and means for determining a threshold, using an indication for the first radio link, for use in selecting candidate hop frequencies for the communications channel from the plurality of frequencies.

### FIELD OF THE INVENTION

Embodiments of the present invention relate to devices, networks, methods, computer programs and chipsets for use in communicating via a frequency-hopping radio communications channel. In particular, they relate to the selection of candidate hop frequencies for the communications channel that avoid interference.

### BACKGROUND TO THE INVENTION

Bluetooth (trademark) is a low power radio frequency (LPRF) packet communications technology. Bluetooth enabled devices can create ad-hoc wireless networks (piconets) via short-range radio frequency hopping spread spectrum (FHSS) communication links in the 2.4 GHz frequency spectrum. These links may be of the order of 10 to 200 m.

A piconet is controlled by a Master and can contain up to seven Slaves. The piconet has a star-topology with the Master as the central node and the Slaves as dependent nodes. The timing of the piconet is controlled by the Master and the Slaves synchronize their Bluetooth clocks to the Bluetooth clock of the Master.

All communications within the piconet include the Master. A Slave cannot communicate directly with another Slave in the piconet, but instead communicates with the Master which then communicates with the other Slave.

The communications within the piconet are time divided into slots of 625 microsecond duration.

The frequency at which a communication is made is dependent upon the time slot at which it begins. The Master defines a frequency hopping sequence (FHS) that all the devices in a piconet share. The sequence is derived from the Bluetooth address of the Master. The normal frequency-hopping interval in a Bluetooth connection is a slot (625 microseconds). However, if the piconet uses the same channel mechanism, which is introduced in Bluetooth 1.2 Specification, the slave responds to the master on the same frequency as it received the master transmission.

Bluetooth devices with power control capability optimize the output power in a physical link. The receiving device measures RSSI and reports back to the transmitting device whether the transmission power should be increased or decreased if possible. This type of power control loop is also known in cellular telecommunication systems.

Normally communication within the Bluetooth network is via a radio communications channel having a frequency that hops between 79 potential frequencies.

The unlicensed ISM frequency band (2400-2483.5 MHz) is used by the variety of systems e.g. (IEEE 802.11 b/g and Bluetooth). In addition, microwave ovens, and e.g. harmonics of the GSM 850 and IS-95 cause interference in the band. If the interference or traffic of other system occurs at the same time on the same frequency channel as the Bluetooth network then the data throughput of the network is degraded. It would therefore be useful to use the frequency channels that have less interference.

Adaptive frequency hopping is a procedure that does this. N ‘good’ candidate frequencies (79>N>20) are selected from the 79 potential frequencies. The candidate frequencies are defined by a channel map, determined at the Master and communicated to the Slaves using AFH_channel_map PDU. The channel map identifies which of the potential 79 frequencies are in use and which are not in use.

The Master determines the channel map from channel classifications made by itself and/or from channel classification reports made by the Slaves and communicated to it in the AFH_channel_classification PDU. This PDU indicates whether the frequency channels are good or bad.

If a frequency channel has only good classifications then it is selected as a candidate frequency for the network and if it has a bad classification from any device then it is unused. This is recorded in the channel map. Each channel classifications therefore records the candidate frequencies selected by one of the devices performing the classification and the channel map records the candidate frequencies selected by the Master for the network

The manner in which the devices assess whether a channel is good or bad is not defined by the BLUETOOTH Specification at present.

Typically during the connection a device can measure whole band. These measurements can be based e.g. on Received Signal Level measurement or Packet Error Rate (PER) measurement. When the device compares those measured values to certain reference value it can estimate whether there is interference on that particular channel or not.

One approach is to use a fixed RSSI threshold. The noise signal in a frequency channel that is not being used to transmit a packet to or from the device is detected. If the RSSI for the noise signal is above the fixed threshold it is classified as bad, whereas if it is below the fixed threshold it is classified as good.

The quality of a communication link between a Master and a Slave depends in part upon the environment of the Master and Slave and the distance between the Master and Slave. If the Master and Slave are physically close to each other and in line of sight then the radio link between them is likely to be robust against interference. It is therefore possible that frequency channels will be classified as bad using the fixed threshold which are capable of being used for communication between the Master and Slave. If a Master and Slave are physically distant from one another and/or not in line of sight then the radio link between them may be susceptible to interference. It is therefore possible that channels will be classified as good using the fixed threshold which are incapable of being used for communication between the Master and Slave.

### BRIEF DESCRIPTION OF THE INVENTION

According to one embodiment of the invention there is provided a device for communicating via a radio communications channel, having a frequency that can hop between a plurality of frequencies, in a network comprising a plurality of devices, the device comprising: a radio transceiver for communicating with a first one of the plurality of devices via a first radio link using the radio communications channel; and

means for determining a threshold for use in selecting candidate hop frequencies for the communications channel from the plurality of frequencies.

According to another embodiment of the invention there is provided a network comprising a first device and at least a second device and operable to use a radio communications channel having a frequency that can hop between a plurality of frequencies, comprising: a radio transceiver for communicating between the first and second devices via a radio link that uses the radio communications channel; means for determining a threshold for the network using at least an indication for the first radio link; means for selecting, using the threshold, candidate hop frequencies from the plurality of frequencies; and means for controlling the radio communications channel to hop between only candidate hop frequencies.

According to another embodiment of the invention there is provided a chipset for controlling a radio communications channel, in a network comprising a plurality of devices, having a frequency that can hop between a plurality of frequencies, the chipset comprising: means for controlling a radio link with a device that uses the radio communications channel; and means for determining a threshold, using an indication for the radio link, for use in selecting candidate hop frequencies for the communications channel.

According to another embodiment of the invention there is provided a computer program which when loaded into a processing unit provides: means for determining a threshold, using an indication for an established radio link, for use in selecting candidate frequencies for the communications channel.

According to another embodiment of the invention there is provided a method for use in a device communicating, via a radio communications channel, in a network comprising a plurality of devices, the method comprising: a) communicating with a first device via a first radio link, wherein the first link uses a radio communications channel having a frequency that can hop between a plurality of frequencies; b) determining a threshold using an indication for at least the first radio link for use in selecting candidate hop frequencies for the communications channel; and c) communicating with the first device via the first radio link using a radio communications channel having a frequency that hops between only selected candidate hop frequencies.

Using a quality indication for a radio link when determining the threshold used in selecting candidate hop frequencies improves the selection process as it is not assumed that every Slave device is in the same environment or position.

It is possible to determine a threshold for each link of the network and classify the frequency channels for a link using that link's threshold. The classifications of the links can then be used to select the candidate hop frequencies. It may therefore be possible to ensure that the candidate frequencies provide an adequate Signal to Noise ratio for each link of the network.

It is also possible to determine a threshold for the network and classify the frequency channels for a link using that threshold. The classifications of the links can then be used to select the candidate hop frequencies. It may therefore be possible to ensure that the candidate frequencies provide an adequate Signal to Noise ratio on all links of the network.

### BRIEF DESCRIPTION OF THE DRAWINGS

For a better understanding of the present invention reference will now be made by way of example only to the accompanying drawings in which:

FIG. 1 illustrates an ad-hoc wireless network comprising a Master device and a plurality of Slave devices;

FIG. 2 illustrates a novel method for determining the candidate hop frequencies;

FIG. 3 illustrates a process for calculating the threshold;

FIG. 4 illustrates a device 10 that is operable as a Slave/Master in the network; and

FIG. 5 illustrates a record medium embodying computer program instructions.

### DETAILED DESCRIPTION OF EMBODIMENTS OF THE INVENTION

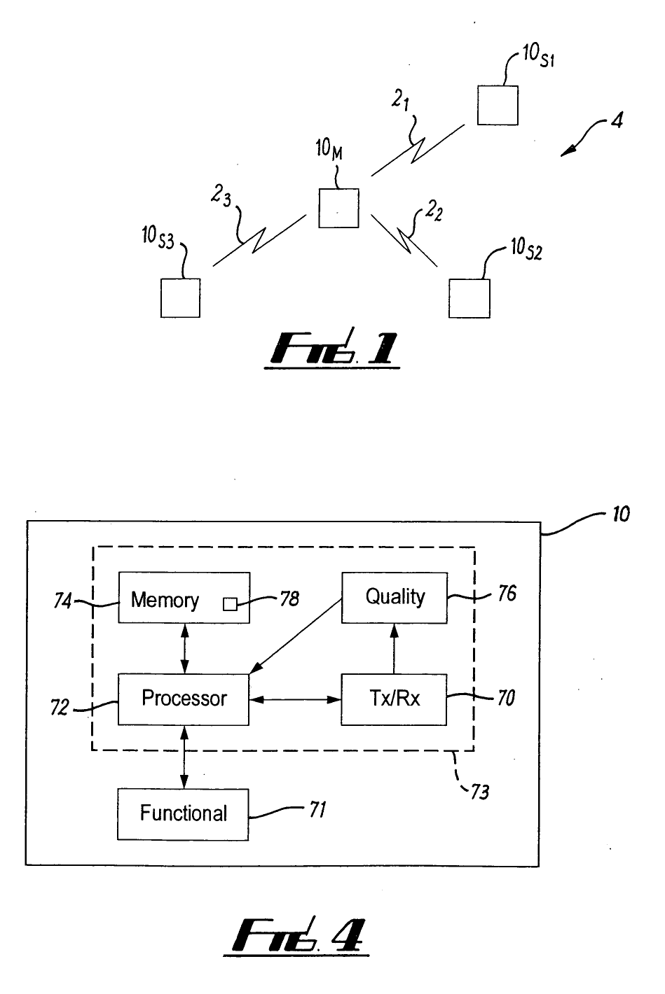

FIG. 1 illustrates an ad-hoc wireless network 4 comprising a Master device 10_{M} and a plurality of Slave devices 10_{S1}, 10_{S2}, 10_{S3}. The network 4 is a Bluetooth network and has a star topology with the Master 10_{M} at the centre. The Master 10_{M} can communicate with any one of the Slaves, but each Slave can communicates with only the Master and not the other Slaves.

The network 4 uses a frequency hopping channel that hops between up to 79 different frequencies. The hop sequence that is followed by the network is determined by the Bluetooth Address of the Master and the timing of the hops is determined by the Bluetooth Clock of the Master.

In this example, the Master 10_{M} is in active communication with the Slaves 10_{S1}, 10_{S2}, 10_{S3} via the respective radio links 2₁, 2₂, 2₃. A radio link 2 is formed according to the link establishment procedure and involves authentication of the devices.

When the network 4 operates without Adaptive Frequency Hopping, the network uses a frequency hopping channel that hops between up to 79 different frequencies.

When the network 4 operates with Adaptive Frequency Hopping, the network uses a frequency hopping channel that hops between up to N different candidate hop frequencies where 20<N<79.

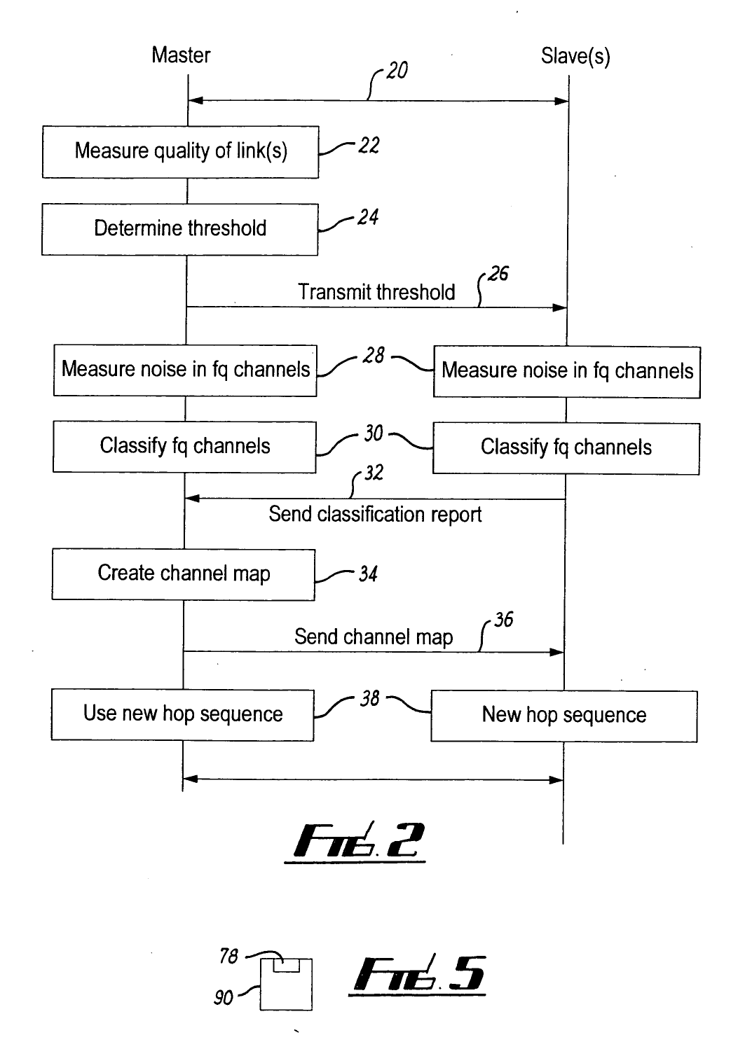

FIG. 2 illustrates a novel method for determining the candidate hop frequencies for the Bluetooth network 4.

At step 20, the Master device 10_{M} and Slave devices 10_{S1}, 10_{S2}, 10_{S3} are communicating via respective radio links 2₁, 2₂ and 2₃ using a first communications channel. This channel is a frequency hopping channel that hops between up to 79 different frequencies.

At steps 22, 24 the Master device 10_{M} determines a threshold using a quality indication for one or more of the radio links 2. This threshold is for use in steps 30, in the Master and Slave devices, where candidate hop frequencies are selected for the communications channel.

At step 22, the Master device 10_{M} measures the quality of the one or more radio links 2. The quality measurement of a radio link is made at the same time as a radio packet is correctly received via that radio link. The timing may be synchronized by detecting the Access code of the correctly received packet. Typically the quality measurement is a Received Signal Strength Indication (RSSI). The RSSI measurement is a quality indication because it is a measurement relating to a desired signal. Other alternative types of quality indication may be used, such as for example Packet Error Rate (PER).

At step 24, the Master device 10_{M} determines the threshold.

In a first embodiment, at step 22, the Master device 10_{M} measures the quality of one radio link 2. The radio link is selected based on a suitable criterion. For example, the most used radio link may be selected, or the radio link with the highest quality of service requirement may be selected or the radio link with the lowest latency requirement may be selected. The Master device 10_{M} may measure multiple quality indications for that link over a set period of time. A quality indication is measured for one or more radio packets that are correctly received on the selected radio link during that period of time. Then at step 24, an average of the measured quality indications is calculated and a predetermined value is subtracted from the average to give the threshold. This guarantees an adequate Signal to Noise ratio on the link. The predetermined value may, for example, be 20 dB. The threshold is, however, constrained to lie within upper and lower boundary limits.

In a second embodiment, at step 22, the Master device 10_{M} measures the quality of multiple radio links 2. The Master device 10_{M} may measure multiple quality indications for the radio links over a set period of time. A quality indication is measured for each radio packet that is correctly received on any of the radio links during that period of time. At step 24, an average of the all measured quality indications from all the links is calculated and a predetermined value is subtracted from the average to give the threshold. The predetermined value may, for example, be 20 dB. The threshold is, however, constrained to lie within upper and lower boundary limits.

In a third embodiment, at step 22, the Master device 10_{M} measures the quality of multiple radio links 2. The Master device 10_{M} may measure multiple quality indications for the radio links over a set period of time. A quality indication is measured for each radio packet that is correctly received on any of the radio links during that period of time. At step 24, a link threshold is separately calculated for each radio link and then one of the thresholds is selected. For each link, an average of the measured quality indications for that link is calculated and a predetermined value is subtracted from the average to give a threshold. The predetermined value may, for example, be 20 dB. The threshold is, however, constrained to lie within upper and lower boundary limits. One of the thresholds is then selected as the network threshold. The selection is based on a suitable criterion. The threshold that is selected may for example be the lowest threshold or may be associated with the most used radio link, the radio link with the highest quality of service requirement or the radio link with the lowest latency requirement. In this example, the subtraction of the predetermined value occurs before selection but it is also possible for selection to precede the subtraction of the predetermined value if it is constant for all the links.

In an alternative implementation of the third embodiment, instead of calculating a single network threshold from a plurality of link thresholds the Master sends each of the link thresholds along its respective link for use by the Slave terminating that link in the classification step 30.

An example of a process for calculating the threshold is illustrated in detail in FIG. 3. At step 50 a new packet is correctly received and its RSSI is measured. At step 52, a cumulative total of the measured RSSI is calculated. After a predetermined period of time, or after enough RSSI measurements have been made, the process moves to step 54. At step 54, the average RSSI is calculated. Then at step 56, e.g. 20 dB is subtracted from the average value. If the result of the subtraction is greater than an upper threshold boundary limit (maximum_RSSI_threshold) then the threshold is set to the upper boundary limit at step 57, 58. If the result of the subtraction is less than or equal to an upper threshold boundary limit (maximum_RSSI_threshold) then the threshold is set to the result at step 58.

Returning to FIG. 2, at step 26, the Master device 10_{M} transmits the threshold to the Slave devices.

At step 28, the Master device 10_{M} and the Slave devices 10_{S} measure a noise indication for the signals received at each of the 79 frequencies. The devices know the frequency hop sequence used by the communication channel of the network 4.

The devices make their measurements at a time and at a radio frequency that avoids collision with the hop sequence of the network 4. Consequently, the measured signal represents noise i.e. signals that do not originate from the network 4. The noise indication measured may be the Received Signal Strength Indication (RSSI).

At step 30, the frequencies are classified using the threshold distributed at step 26. This involves selecting, using the determined threshold, local candidate hop frequencies for use in the communications channel from the plurality of frequencies. If the noise indication for a frequency exceeds the threshold then the frequency is classified as ‘bad’, that is unusable because of interference. If the noise indication for a frequency does not exceed the threshold then the frequency is classified as ‘good’, that is usable. The local candidate hop frequencies are those classified as good. These are ‘local’ candidates as they may be unsuitable for use in the network because of local interference elsewhere in the network. The candidate hop frequencies are identified in a classification report. Each Slave sends its classification report to the Master at step 32.

At step 34, the Master device 10_{M} creates a channel map from the received classification reports and its own classification report. If a frequency channel has only good classifications in the classification reports then it is selected as a candidate frequency for the network as it is free of interference throughout the network. If a frequency channel has a bad classification in any one of the classification reports then it is not selected as a network candidate frequency.

At step 36, the Master device 10_{M} sends the channel map to the Slaves.

At step 38, the Master and Slaves use a new hop sequence based on the channel map. They communicate using a new radio communications channel having a frequency that hops between only some or all of the network candidate hop frequencies.

Although in the above described embodiments, the Master device 10_{M} measures the quality of the one or more radio links 2 at step 20. In other embodiments it is possible for one or more of the Slave devices to measure the quality of the one or more radio links 2. The Slave or Slaves would then transmit the measurements to the Master device. Measurement at the Slave(s) may be as an alternative or as an addition to measurement at the Master.

Although in the above described embodiments, the Master device 10_{M} determines the threshold at step 22. In other embodiments it is possible for one of the Slave devices to determine the threshold. The Slave would then transmit the threshold to the Master.

Although in the above described embodiments a single network threshold is calculated and then distributed, in other embodiments each Slave device that performs the step 30 of classifying the frequency channels can calculate its own link threshold for use in that step. In these embodiments, there is no step corresponding to step 26 and the steps 22, 24, 28 and 30 are performed in the same device. The step 22 when carried out by a Slave device measures the quality of the link with the Master and calculates a link threshold, for example, using the method illustrated in FIG. 3. This link threshold is then used to classify the frequency channels at the Slave device.

The method of steps 22 to 38 is then repeated at a later time, for example periodically. The method of steps 22 to 26 may occur independently to the method according to steps 28 to 38. The method of steps 22 to 26 may occur with a first periodicity and the method of claims 28 to 38 may occur with a second, shorter periodicity (greater frequency).

The use of upper and lower boundary limits for the threshold is advantageous. The upper limit obviates the selection of a frequency channel that collides with and degrades other transmissions such as WLAN transmissions. The minimum level ensures that there are at least some candidate hop frequencies in conditions when the quality of the radio links is poor. The upper limit will be used if the Slave devices are very close to the Master and the lower limit will be used when the Slave devices are very far from the Master. The threshold limits may be adapted

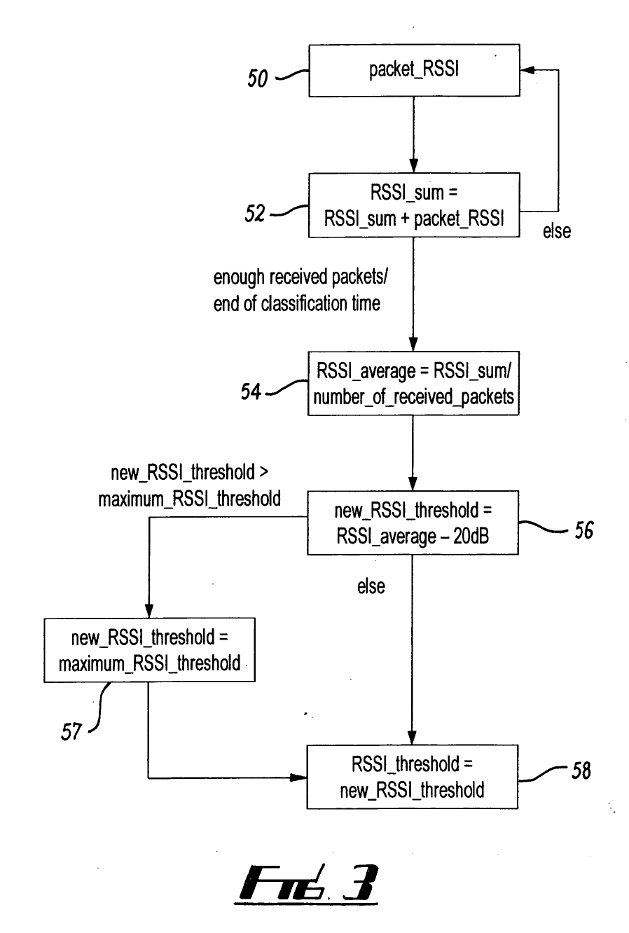

FIG. 4 illustrates a device 10 that is operable as a Slave and as a Master.

The device comprises: a radio transceiver 70 for communicating using the radio communications channel; a processor 72; a memory 74, circuitry 76 for measuring a quality indication of a frequency channel and functional circuitry 71.

The processor 72 is connected to read from and write to the memory 74 and is connected to receive data from and provide data to the radio transceiver 70.

The circuitry 76 for measuring a quality indication of a frequency channel is connected to the radio transceiver 70 and the processor 72. In other implementations it may be integrated with the radio transceiver. The circuitry 76 is operable to measure the quality indications and the noise indications described above.

The memory 74 stores computer program instructions 78, which when loaded into the processor 72 controls the operation of the device 10. When the device is operating as a Master the computer program instructions control the device to perform the method steps to the left of FIG. 2 that are performed by the Master. When the device is operating as a Slave the computer program instructions control the device to perform the method steps to the right of FIG. 2 that are performed by the Slaves.

The computer program instructions 78 may be received at the device via an electromagnetic carrier signal received via a radio transceiver or may be transferred from a physical entity 90 such as a record medium e.g. CD-ROM, solid state memory etc as illustrated in FIG. 5

The functional circuitry 71 is connected to the processor 72 and provides functionality not relating to the Bluetooth network 4. It may, for example, provide a display, an input device and applications if the device is operable as a personal digital assistant, for example, or provide a display, an input device, a cellular radio transceiver and applications if the device is operable as a cellular mobile telephone.

In this example, the combination of processor 72, memory 74, computer program instructions 78 and circuitry 76 provide the means referred to below. In other implementations, the means may be provided by dedicated circuits such as ASICs.

The device 10 comprises:

a) means for obtaining a quality indication for a radio link by measuring the quality of the radio link as a radio packet is correctly received via that link.

b) means for determining a threshold using one or more quality indications for one or more radio links.

c) means for averaging a plurality of quality indications and determining the threshold using the average and calculating the threshold from the average. The quality indications may be for the same link or for multiple different links.

In the first embodiment, the means for determining the threshold is operable to calculate a average of the quality indications of a single link.

In the second embodiment, the means for determining the threshold is operable to calculate a single average of the quality indications of the multiple different links.

In the third embodiment, the means for determining the threshold is operable to calculate an average of the quality indications for each of the multiple different links and selects an average. The selection may involve one of: selecting the lowest quality average; selecting the average associated with the most used link; or selecting an average based on at least one Quality of Service requirement.

The combination of processor 72, memory 74, computer program instructions 78, circuitry 76 and radio transceiver 70 may be sold as a chipset 73. A chipset is a set of integrated circuits that have a specific purpose in a computer system. The purpose of the chipset is to enable a device using the chipset to participate in a Bluetooth network and to perform one or more embodiments of the invention. The radio transceiver circuitry and possibly the circuitry 76 may be part of a separate RF chipset. In this case the processor 72, memory 74, computer program instructions 78 for a base band chipset.

The chipset 73 consequently comprises means for controlling a radio link with a device that uses the radio communications channel; and means for determining a threshold, using a quality indication for the radio link, for use in selecting candidate hop frequencies for the communications channel.

The computer program 78 when loaded into the processor provides the means for determining a threshold, using a quality indication for an established radio link, for use in selecting candidate frequencies for the communications channel. The computer program instructions may be provided separately to the chipset, for example, on a record carrier such as a CD-ROM, etc

Although embodiments of the present invention have been described in the preceding paragraphs with reference to various examples, it should be appreciated that modifications to the examples given can be made without departing from the spirit and scope of the invention.

I claim:

1. A device for communicating via a radio communications channel, having a frequency that can hop between a plurality of frequencies, in a network comprising a plurality of devices, the device comprising:
a radio transceiver for communicating with a first one of the plurality of devices via a first radio link using the radio communications channel; and
means for determining a threshold for use in selecting candidate hop frequencies for the communications channel from the plurality of frequencies.

2. A device as claimed in claim 1, wherein the means for determining determines the threshold using a quality indication for the first radio link,

3. A device as claimed in claim 2, wherein the quality indication is RSSI.

4. A device as claimed in claim 2, further comprising means for obtaining the quality indication for the radio link by measuring the quality of the first radio link as a radio packet is correctly received via the first radio link.

5. A device as claimed in claim 2, wherein the radio transceiver is operable to receive the quality indication for the first radio link from the first device.

6. A device as claimed in claim 2, wherein the means for determining a threshold subtracts a value from the quality indication to obtain the threshold.

7. A device as claimed in claim 1, wherein the means for determining the threshold averages a plurality of indications and determines the threshold using the average.

8. A device as claimed in claim 7, wherein the indications are quality indications for the same link.

9. A device as claimed in claim 7, wherein the indications are quality indications for multiple different links.

10. A device as claimed in claim 9, wherein the means for determining the threshold calculates a single average of the quality indications of the multiple different links.

11. A device as claimed in claim 9, wherein the means for determining the threshold calculates an average of the quality indications for each of the multiple different links and selects an average.

12. A device as claimed in claim 11, wherein selection involves one of: selecting the lowest quality average; selecting the average associated with the most used link; or selecting an average based on at least one Quality of Service requirement.

13. A device as claimed in claim 7, wherein the means for determining a threshold subtracts a value from the average to obtain the threshold.

14. A device as claimed in of claim 7, further comprising means for obtaining at least some of the indications by measuring the radio links when radio packets are correctly received via the radio links.

15. A device as claimed in claim 7, wherein the radio transceiver is operable to receive at least some of the indications.

16. A device as claimed in claim 1, wherein the threshold is constrained within limits.

17. A device as claimed in claim 16, wherein the limits are adaptable.

18. A device as claimed in claim 1, further comprising means for initiating determination of the threshold periodically.

19. A device as claimed in claim 1, wherein the radio transceiver is operable to transmit the determined threshold.

20. A device as claimed in claim 1, wherein the device is operable as a Slave and the radio transceiver is operable to transmit a classification report to a Master device in the network, the device further comprising selection means for selecting, using the determined threshold, candidate hop frequencies for use in the communications channel from the plurality of frequencies and for including the candidate hop frequencies in the classification report.

21. A device as claimed in claim 1, wherein the device is operable as a BLUETOOTH Master and the radio transceiver is operable to receive classification reports from the Slave devices in the network and transmit a channel map to the Slave devices in the network, the device further comprising selection means for selecting, using the received classification reports, the candidate hop frequencies for use in the communications channel from the plurality of frequencies and for including the candidate hop frequencies in the channel map.

22. A network comprising a first device and at least a second device and operable to use a radio communications channel having a frequency that can hop between a plurality of frequencies, comprising:
radio transceiver for communicating between the first and second devices via a radio link that uses the radio communications channel;
means for determining a threshold using at least an indication for the first radio link;
means for selecting, using the threshold, candidate hop frequencies from the plurality of frequencies; and
means for controlling the radio communications channel to hop between only candidate hop frequencies.

23. A network as claimed in claim 22, wherein the indication is a quality indication.

24. A network as claimed in claim 22, wherein the threshold is a network threshold used throughout the network in selecting candidate hop frequencies.

25. A network as claimed in claim 22, wherein the threshold is one of a plurality of link thresholds each of which is used in selecting candidate hop frequencies for a respective link.

26. A chipset for controlling a radio communications channel, in a network comprising a plurality of devices, having a frequency that can hop between a plurality of frequencies, the chipset comprising:
means for controlling a radio link with a device that uses the radio communications channel; and
means for determining a threshold, using an indication for the radio link, for use in selecting candidate hop frequencies for the communications channel.

27. A computer program which when loaded into a processing unit provides:
means for determining a threshold, using an indication for an established radio link, for use in selecting candidate frequencies for the communications channel.

28. A physical entity embodying the computer program as claimed in claim 27.

29. A record medium embodying the computer program as claimed in claim 27.

30. A method for use in a device communicating, via a radio communications channel, in a network comprising a plurality of devices, the method comprising:
a) communicating with a first device via a first radio link, wherein the first link uses a radio communications channel having a frequency that can hop between a plurality of frequencies;
b) determining a threshold using an indication for at least the first radio link for use in selecting candidate hop frequencies for the communications channel; and
c) communicating with the first device via the first radio link using a radio communications channel having a frequency that hops between only selected candidate hop frequencies.

31. A method as claimed in claim 30, comprising repeating step b).

32. A method as claimed in claim 30, further comprising, after step b), transmitting the threshold to at least the first device.

33. A method as claimed in claim 30, wherein step b) comprises averaging a plurality of indications.

34. A method as claimed in claim 33, wherein the indications are for multiple different links and step b) further comprises calculating a single average of the indications of the multiple different links.

35. A method as claimed in claim 33, wherein the indications are for multiple different links and step b) further comprises calculating an average of the indications for each of the multiple different links and selecting an average.

36. A method as claimed in claim 33, wherein step b) comprises subtracting a value from the average to obtain the threshold.

37. A method as claimed in claim 33, further comprising obtaining at least some of the indications by measuring the quality of radio links when radio packets are correctly received via the radio links.

38. A method as claimed in claim 33, further comprising receiving at least some of the indications.
